(19) United States
(12) Patent Application Publication
(10) Pub. No.: US 2026/0227296 A1
(43) Pub. Date: Aug. 6, 2026

(54) GASTROINTESTINAL TRACT SIMULATOR

(71) Applicant: MAK Wood, Inc., Grafton, WI (US)

(72) Inventor: Olivia Stiker, Grafton, WI (US)

(21) Appl. No.: 19/409,407

(22) Filed: Dec. 4, 2025

Related U.S. Application Data
(60) Provisional application No. 63/882,078, filed on Sep. 15, 2025.
(60) Provisional application No. 63/728,037, filed on Dec. 4, 2024.

(51) Int. Cl. G01N 1/28; G01N 1/44; G01N 1/38

(52) U.S. Cl. CPC G01N 1/286; G01N 1/44; G01N 2001/2866; G01N 2001/386

(57) ABSTRACT

A gastrointestinal tract simulator for simulating the breakdown of a first substance including a sac having a deformable body and at least partially defining a first chamber therein, where the first chamber is configured to receive the first substance therein, a first fluid contained within the first chamber, and an agitation assembly engaging the sac, where the agitation assembly is configured to deform the body of the sac.

### RELATED APPLICATIONS

This application claims priority to U.S. Provisional Application No. 63/728,037, filed on December 4, 2024, and U.S. Provisional Application No. 63/882,078, filed on September 15, 2025. The entire contents of both applications are hereby incorporated by reference.

### FIELD

The present disclosure generally relates to a gastrointestinal tract simulator, and more specifically a gastrointestinal tract simulator that can reproduce the churning, temperature, and chemical conditions found in a human or other entities stomach.

### BACKGROUND

Different substances, such as foodstuffs, medicines, supplements, liquids, and solids, interact and breakdown differently within an entity’s stomach as a result of the various chemical reactions, thermal conditions, and churning action of the items within the stomach.

### SUMMARY

In one aspect, a gastrointestinal tract simulator for simulating the breakdown of a first substance, the gastrointestinal tract simulator including a sac having a deformable body and at least partially defining a first chamber therein, where the first chamber is configured to receive the first substance therein; a first fluid contained within the first chamber; an agitation assembly engaging the sac, where the agitation assembly is configured to deform the body of the sac.

Alternatively or additionally, in any combination, where the body is impermeable to the first liquid.

Alternatively or additionally, in any combination, where the body at least partially forms a first layer, the gastrointestinal tract simulator further comprising a second layer at least partially encompassing the first layer.

Alternatively or additionally, in any combination, where the second layer is formed from a different material than the first layer.

Alternatively or additionally, in any combination, where the first layer is formed from a plastic material and the second layer is formed from a fabric.

Alternatively or additionally, in any combination, where at least a portion of the body of the sac is transparent so that the first chamber can be viewed therethrough.

Alternatively or additionally, in any combination, where the gastrointestinal tract simulator also includes a rigid frame defining a first interior volume therein, and where the sac is at least partially positioned within the first interior volume.

Alternatively or additionally, in any combination, where the first fluid includes hydrochloric acid.

Alternatively or additionally, in any combination, where the first fluid has a pH between 1.3 and 3.5.

Alternatively or additionally, in any combination, where the first fluid has a pH between 1.3 and 1.8.

Alternatively or additionally, in any combination, where the agitation assembly includes an agitation head rotatable about a first axis, and wherein rotation of the agitation head about the first axis causes the body of the sac to deform.

Alternatively or additionally, in any combination, where the agitation head includes a protrusion extending from the agitation head, where the protrusion is spaced a distance from the first axis, and wherein the protrusion is configured to engage the sac.

Alternatively or additionally, in any combination, where the protrusion extends from the agitation head in a direction parallel to the first axis.

Alternatively or additionally, in any combination, where the protrusion is a first protrusion, the agitation head further including a second protrusion spaced 180 degrees from the first protrusion and offset from the first axis.

Alternatively or additionally, in any combination, where the agitation head is positioned completely outside the first chamber.

Alternatively or additionally, in any combination, where the gastrointestinal tract simulator also includes a heater assembly, and where the heater assembly is configured to maintain at least a portion of the agitation head at a pre-determined temperature.

Alternatively or additionally, in any combination, where the heater assembly is configured to maintain the first fluid between 90 and 105 degrees Fahrenheit.

Alternatively or additionally, in any combination, where the heater assembly is configured to maintain the first fluid between 95 and 100 degrees Fahrenheit.

In another aspect, a gastrointestinal tract simulator for simulating the breakdown of a first substance therein, the gastrointestinal tract simulator comprising: a sac having a deformable body and at least partially defining a first chamber therein, where the first chamber is configured to receive the first substance therein, a first fluid contained within the first volume, an agitation assembly configured to agitate the first fluid within the first volume.

Alternatively or additionally, in any combination, where the gastrointestinal tract simulator also includes a heater assembly configured to maintain the first fluid at a predetermined temperature.

In another aspect, a method of simulating the breakdown of a first substance within a gastrointestinal tract, the method comprising: providing a sac with a deformable body, where the sac defines a first chamber therein; at least partially filling the first chamber with a first fluid; placing the first substance within the first chamber; agitating the first fluid within the first chamber; and warming the first fluid to a temperature between 90 and 105 degrees.

Alternatively or additionally, in any combination, where placing the first substance within the first chamber includes placing a foodstuff within the first chamber.

Alternatively or additionally, in any combination, where agitating the first fluid within the first chamber includes deforming the body of the sac.

Alternatively or additionally, in any combination, where filling the first chamber with a first fluid includes filling the first chamber with a first fluid having a pH between 1.3 to 3.5.

### BRIEF DESCRIPTION OF THE DRAWINGS

FIG. 1 is schematic view of a gastrointestinal tract simulator according to the current description.

FIG. 2 is a top perspective view of the gastrointestinal tract simulator of FIG. 1.

FIG. 3 is a top view of the gastrointestinal tract simulator of FIG. 1.

FIG. 4 is another top perspective view of the gastrointestinal tract simulator of FIG. 1.

FIG. 5 is a top view of the gastrointestinal tract simulator of FIG. 1 with the liner and sacs removed.

FIG. 6 is a top view of the agitation and thermal assemblies of the gastrointestinal tract simulator of FIG. 1.

FIG. 7 illustrates the frame of the gastrointestinal tract simulator of FIG. 1 in a disassembled state.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

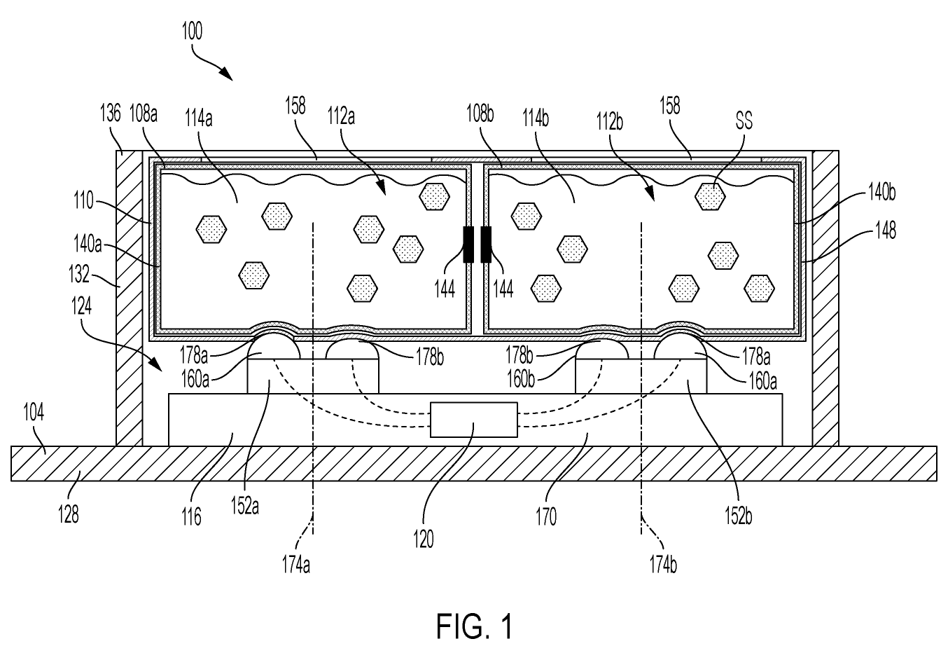

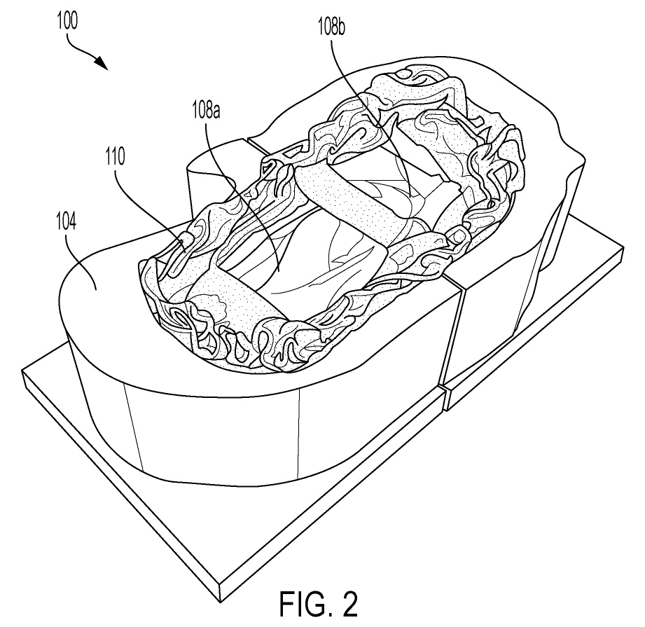

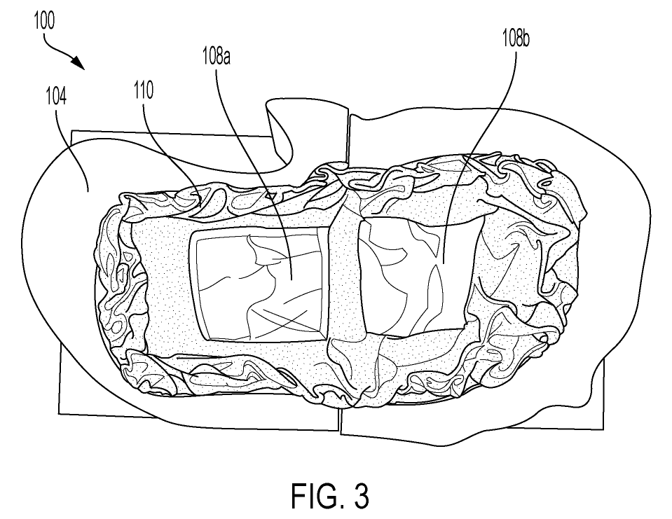

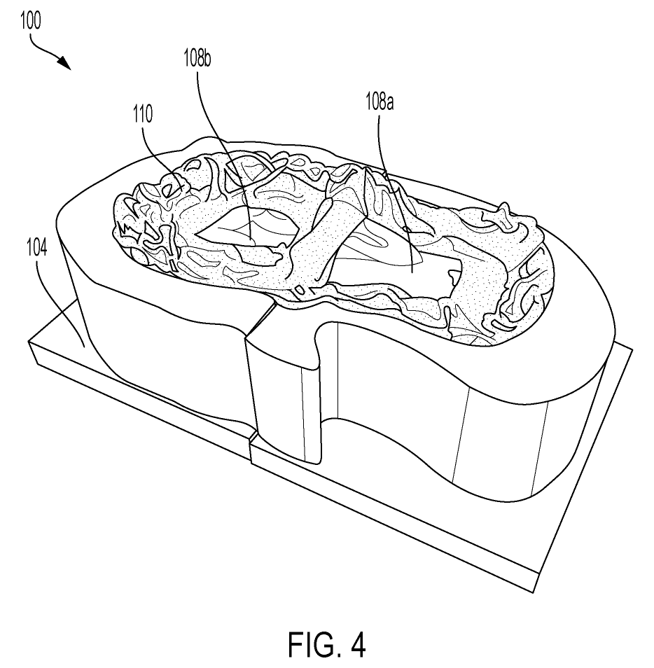

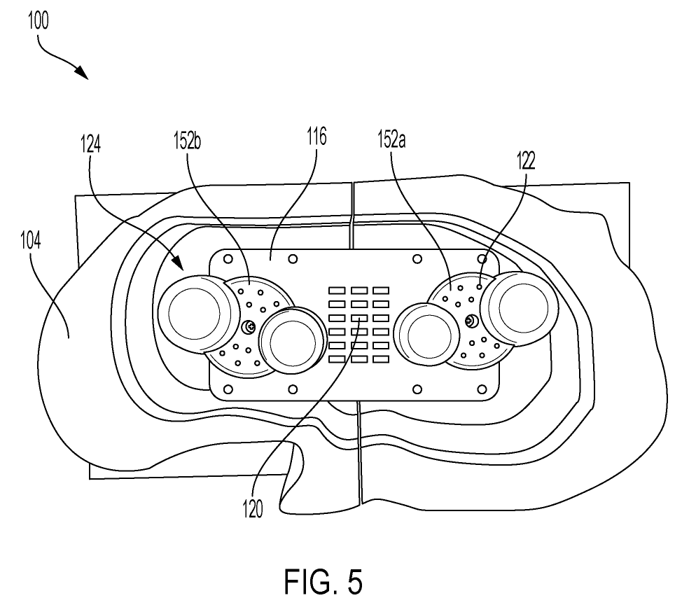

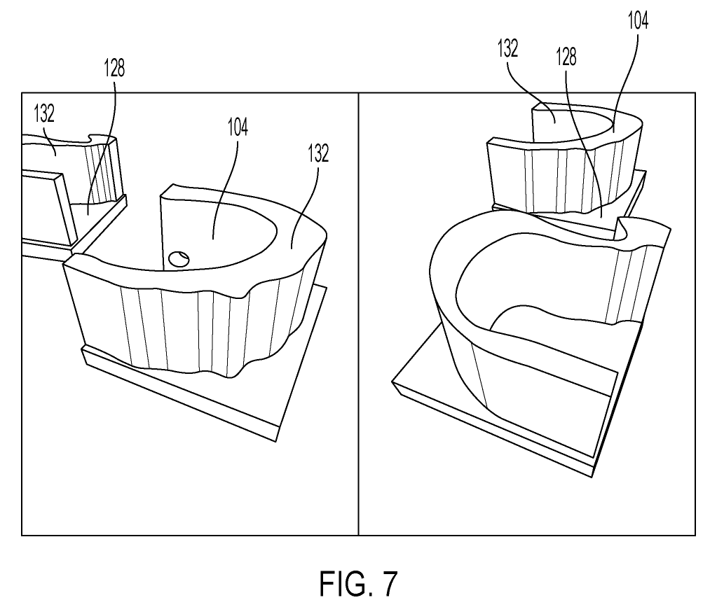

FIGS. 1-7 illustrate a gastrointestinal (GI) tract simulator 100 for simulating the breaking down of various substances (SS, e.g., foodstuffs, medicines, supplements, liquids, solids, and the like) within a subject’s GI system. In some embodiments, the simulator 100 is configured to simulate the breaking down of substances within a subject’s GI tract by reproducing the churning action, temperature, and chemical conditions generally found in a human or other species’ stomach. Still further, the illustrated simulator 100 is also configured so that it can generate the conditions necessary to simulate the breakdown of various substances within a GI environment while also allowing the user to visually observe the simulation in real-time without contaminating or otherwise influencing the simulation itself.

As shown in FIG. 1, the GI tract simulator 100 includes a frame or base 104, a first sac 108a enclosing a first digestion chamber 112a at least partially filled with a first fluid 114a, a second sac 108b enclosing a second digestion chamber 112b at least partially filled with a second fluid 114b, a liner 110 at least partially enclosing the first sac 108a and the second sac 108b, an agitation assembly 116, and a thermal assembly 120. While the illustrated embodiment includes two sacs 108a, 108b allowing for two independent simulations to be carried out simultaneously by a single device, it is understood that in other embodiments more or fewer sacs 108a, 108b may be incorporated into the simulator 100 as desired.

As shown in FIGS. 1-7, the frame or base 104 of the simulator 100 is a rigid structure at least partially defining one or more interior volumes 124 therein. During use, the one or more interior volumes 124 are configured to at least partially receive and support the other elements of the simulator 100 such as, but not limited to, both sacs 108a, b, the liner 110, the agitation assembly 116, and/or the thermal assembly 120. In some embodiments, the frame 104 also provides an aesthetically pleasing or anatomically accurate exterior visual appearance.

In the illustrated embodiment, the frame 104 includes a base wall 128 and one or more side walls 132 extending from the base wall 128 to produce an open or distal end 136 opposite the base wall 128. Together, the base wall 128 and side walls 132 define an interior volume 124 open to the distal end 136 but generally enclosed on the sides and from below. In the illustrated embodiment, the interior volume 124 is sized so that both sacs 108a, b can be placed in the volume 124 side-by-side so that the tops of both sacs 108a, 108b are positioned near and visible through the distal end 136.

While the illustrated interior volume 124 is formed as a single un-divided space open to the distal end 136, it is understood that in other embodiments the interior volume 124 may be sub-divided into two or more sub-volumes to allow both sacs 108a, b to be physically isolated from each other. In such embodiments, the bodies 140a, b of both sacs 108a, b may be supported along their entire horizontal perimeters.

In some embodiments, the frame 104 may be shaped to produce an overall exterior appearance of a human stomach while the interior volume 124 may be shaped to produce an interior shape that generally corresponds to the interior shape of a human stomach. In still other embodiments, the interior and/or exterior shape of the frame 104 may be configured to reproduce the general shape and/or aesthetic appearance of all or portions of the gastrointestinal tract of a human and/or other animal (e.g., a stomach, an esophagus, the intestines, and the like). In still other embodiments, the interior volume 124 may be sized and shaped to correspond to the exterior shape of one or both sacs 108a, b such that side walls 132 serve as support for the bodies 140a, 140b thereof.

In the illustrated embodiment, the frame 104 is formed as two halves, allowing the frame 104 to be disassembled to provide increased access to the interior volume 124 and to allow for ease of manufacture. In other embodiments, the frame 104 may be formed as a single piece, or more than two pieces as needed to allow the individual items of the simulator 100 to be inserted into and removed from the interior volume 124.

As shown in FIG. 1, each sac 108a, b of the simulator 100 includes a first body, first layer, or inner layer 140a, b at least partially enclosing the respective digestion chamber 112a, b therein. In some embodiments, the body 140a, b is deformable such that the size and/or shape of the digestion chamber 112a, b may be altered by manipulating the shape of the body 140a, b itself. In still other embodiments, the body 140a, b is also impermeable to the first and/or second fluids 114a, b, respectively, and formed from material that will not chemically react with the first and second fluids 114a, b during operation. In still other embodiments, the body 140 a, b of each sac 108a, b is also impermeable to and chemically inert with any supplemental substances (e.g., foodstuffs, medicines, supplements, liquids, solids, and the like) to be included in or produced by the simulation itself. In still other embodiments, at least a portion of the body 140 a, b may be transparent so that a user can view the chambers 112a, b during operation without having to disturb or otherwise breach the sealed integrity of the digestion chambers 112a, b. In the illustrated embodiment, both bodies 140a, b are formed from a flexible, chemically inert, and transparent sheet material such as polyethylene. However, in other embodiments different forms of material may be used such as, but not limited to, plastics generally and the like. In still other embodiments where the two sacs 108a, 108b are configured for simulating the breakdown of different supplemental substances, the two sacs 108a, 108b may be formed from different materials having different chemical and physical properties better directed to the specific simulations being carried out.

The bodies 140a, b of the sacs108a, b may also include an access point or port 144 through which selective access to the corresponding digestion chambers 112a, b may be provided. During use, the access point 144 may be adjustable between a closed configuration, in which the corresponding digestion chamber 112a, b is completely enclosed and fluidly isolated from the surrounding environment, and an open configuration, in which the user may access the corresponding digestion chamber 112a, b via the access point 144 (e.g., to introduce or remove fluids and solids from the digestion chamber 112a, b itself). In some embodiments, the access point 144 may include a resealable connection (e.g., a zip lock resealable connection, a slider resealable connection, a zipper resealable connection, an adhesive resealable connection, and the like). In other embodiments, the access point 144 may include other forms of closure such as, but not limited to, a detachable cap, sealable flap or door, weldable lip and the like.

In some embodiments, the bodies 140a, b of the sacs 108a, b may be configured so that the exterior of the sacs 108a, b and/or chambers 112a, b form a predetermined shape. For example, in some embodiments the bodies 140a, b may be configured so that the corresponding chambers 112a, b form a shape that generally corresponds to the size and/or shape of a human stomach. In other embodiments, the bodies 140a, b may be configured so that the chambers 112a, b form a shape that generally corresponds with the size and/or shape of a particular species of animal’s stomach. In still other embodiments, the bodies 140a, b may be configured so that the corresponding chambers 112a, b are shaped to promote a particular flow pattern therein during operation.

While the illustrated bodies 140a, b of both sacs 108a, b are shown being formed completely from a deformable and transparent sheet material, it is understood that in other embodiments only a portion of the body 140a, b may have such characteristics. For example, only a portion of the body 140a, b may be formed from transparent material, producing one or more windows in an otherwise opaque structure. Furthermore, only a portion of the body 140a, b may be deformable, producing one or more deformable panels in an otherwise rigid or semi-rigid body.

As shown in FIG. 1, the liner 110 of the simulator 100 includes a second body, second layer, or outer layer 148 configured to at least partially receive and encompass both sacs 108a, 108b. In the illustrated embodiment, the body 148 of the liner 110 forms an internal volume 142 in which both sacs 108a, b may be positioned. During use, the liner 110 serves to protect the sacs 108a, b by at least partially encompassing each sac 108a, b in a layer of liner material. In some embodiments, the liner 110 is configured so that the body 148 thereof is positioned between the bodies 140a, b of each sac 108a, b and the agitation assembly 116 (e.g., the corresponding agitation head 152a, b, discussed below). By doing so, the liner 110 helps to minimize any wear or abrasion that the agitation assembly 116 may otherwise exert upon the inner layer 140 during operation.

In still other embodiments, the liner 110 may also be used as an aesthetic cover to hide or otherwise limit visual access to the sacs 108a, b, the digestion chambers 112a, b, the agitation assembly 116, and/or the thermal assembly 120. In some embodiments, the liner 110 may include a pair of apertures or windows 158 formed into the body 148, each open to the internal volume 142 and positioned to provide a visual path for a respective sac 108a, b positioned therein. In the illustrated embodiment, the second body 148 is formed from a fabric material. In other embodiments, different flexible and/or wear resistant materials may also be used.

While the illustrated liner 110 is shown completely encompassing both sacs 108a, b in a single internal volume 142, it is understood that in other embodiments, different layouts may be used. For example, in some embodiments, a single liner 110 may produce multiple, separate volumes each configured to receive a single sac 108a, b therein. In other embodiments, multiple liners 110 may be present, each including one or more internal volumes, each configured to receive one or more corresponding sacs 108a, b therein. Still further, while the illustrated liner 110 is separate from each sac 108a, b (e.g., each sac 108a, b sits freely within the volume 142 of the liner 110 without any adhesive or connections therebetween), it is understood that in other embodiments the liner 110 may be adhered or otherwise attached to the sacs 108a, 108b in one or more positions so the body of the sac 108a, b and the body of the liner 110 move together as a single unit.

Furthermore, while the illustrated liner 110 is shown completely encompassing both sacs 108a, b such that the bodies thereof are only visible through the windows 158 contained therein, it is understood that in other embodiments the liner 110 may only partially cover the sacs 108a, b. For example, the liner 110 may only serve as a top cover placed atop the two sacs 108a, b. In other embodiments, the liner 110 may only serve as a wear resistance member and only be positioned where the agitation assembly 116 or thermal assembly 120 engage the sacs 108a, b.

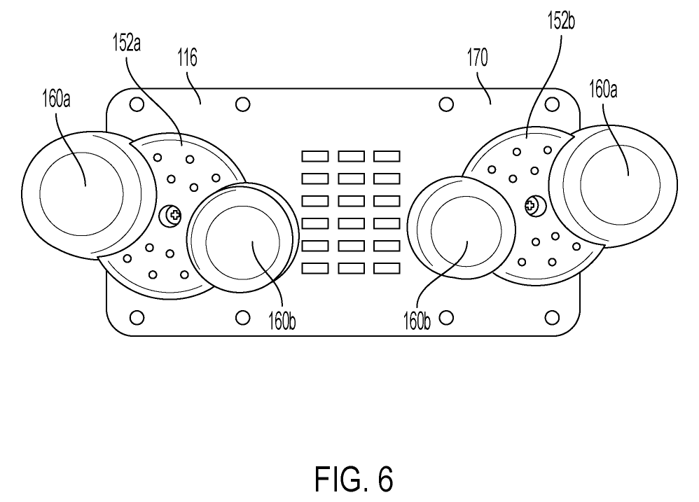

As shown in FIGS. 1 and 6, the agitation assembly 116 of the simulator 100 is in operable communication with both sacs 108a, b and is configured to generate a churning action within the corresponding digestion chambers 112a, b to promote the breakdown of any supplemental substances SS contained therein. In some embodiments, the agitation assembly 116 is configured to agitate the first and/or second fluids 114a, b within the first and second digestion chamber 112a, 112b, respectively, without having to physically contact the first or second fluids 114a, b directly. In still other embodiments, the agitation assembly 116 of the simulator 100 is configured to agitate the first and/or second fluids 114a, 114b within the first and second digestion chambers 112a, b, respectively, while being positioned completely outside the first and second digestion chambers 112a, b. In still other embodiments, the agitation assembly 116 is configured to agitate the first and/or second fluids 114a, b within the first and second digestion chambers 112a, b, respectively, while the corresponding digestion chambers 112a, b remain completely sealed and isolated from the surrounding environment. In still other embodiments, the agitation assembly 116 is configured to engage and manipulate the shape of the body 140a, 140b of the first and second sacs 108a, 108b which, in turn, is configured to cause the first and second fluids 114a, b to agitate.

In some embodiments, the agitation assembly 116 includes a base 170 and one or more agitation heads 152 movable with respect to the base 170 (e.g., by an electric motor and the like, not shown). During operation, the agitation heads 152 are in engagement with the bodies 140a, b of the sacs 108a, b and move with respect to the base 170 to generate a churning action within the

corresponding digestion chambers 112a, 112b. In some embodiments, the heads 152 engage the exterior of the sacs 108a, b such that the motion of the agitation heads 152 with respect to the base 170 cause the bodies 140a, b of the sacs 108a, b to deform, which in turn causes the materials within the corresponding digestion chambers 112a, b (e.g., the first and second fluids 114a, b, supplemental substances SS, and the like) to churn.

In the illustrated embodiment, the agitation heads 152a, b are rotationally attached to the base 170 such that they rotate about an axis of rotation 174a, b during operation. The illustrated agitation heads 152a, b are substantially cylindrical in shape but may include other shapes as desired. In some embodiments, the axis of rotation 174a, b for each agitation head 152a, b is parallel to and offset from each other, with both being in a substantially vertical orientation (see FIG. 1). In still other embodiments, the axis of rotation 174a, b for each agitation head 152a, b is oriented such that the axis itself passes through the corresponding digestion chamber 112a, b of the sac 108a, b to which hit is engaged. While the illustrated agitation heads 152a, b are rotationally attached to the base, it is understood that in other embodiments different forms of movement may be used such as but not limited to translational.

As shown in FIGS. 1 and 6, the agitation heads 152a, 152b also include one or more protrusions or fingers 160a, b extending therefrom. During use, the protrusions 160a, b are configured to engage and manipulate the bodies 140a, b of the sacs 108a, b to increase the churning action. In the illustrated embodiment, each agitation head 152a, 152 includes two protrusions 160a, b each extending from the agitation head 152a, 152b in a direction substantially parallel to the axis of rotation 174a, b. The illustrated protrusions 160a, 160b are each spaced a distance from the axis of rotation 174a, b and placed opposite each other (e.g., 180 degrees apart). In other embodiments, more or fewer protrusions 160a, 160b may be present and they may be located in different positions relative to each other and relative to the axis of rotation 174a, b. For example, while the illustrated protrusions 160a, b are spaced evenly about the axis of rotation 174a, b, in other embodiments the protrusions may be unevenly spaced about the axis of rotation 174a, b. Furthermore, while the illustrated protrusions 160a, b are all positioned at the same radial distance from the axis of rotation 174a, b in other embodiments the protrusions 160a, b may be placed a different radial distances from the axis of rotation 174a, b. In still other embodiments, the agitation heads 152a, b may include a protrusion 160a extending in a direction parallel to the axis of rotation 174a, b.

In the illustrated embodiment, both protrusions 160a, b are generally cylindrical in shape having a rounded or otherwise semi-circular distal ends 178a, b. The illustrated protrusions 16a, b are also different sizes, with one protrusion having a larger outer diameter and longer axial length than the other. In other embodiments, different sizes and shapes of protrusions may be present. In still other embodiments, all protrusions 160a, b may be the same size and shape.

In the illustrated embodiment, the agitator assembly 116 is positioned in the bottom of the interior volume 124 of the frame 104 with the two agitation heads 152a, b facing upwardly toward the open end 136. As shown in FIG. 1, the illustrated assembly 116 is positioned so that a corresponding sac 108a, b is positioned vertically above and rests on each agitation head 152a, 152b with the liner 110 positioned therebetween. While the illustrated agitation heads 152a, 152b engage the sacs 108a, b indirectly (e.g., through the liner 110), it is understood that in other embodiments the agitation heads 152a, b may engage the sacs 108a, b directly (e.g., with no liner present).

As shown in FIG. 1, the thermal assembly 120 of the simulator 100 is configured to regulate the temperature of the contents of the first and second digestion chambers 112a, b. In some embodiments, the thermal assembly 120, may selectively apply heat to the sac 108a, b to maintain the temperature at a predetermined value. In some embodiments the thermal assembly 120 may maintain the temperature of the digestion chamber 112a, b to between 90 degrees Fahrenheit and 105 degrees Fahrenheit. In other embodiments the thermal assembly 120 may maintain the temperature of the digestion chamber 112a, b to between 85 degrees Fahrenheit and 110 degrees Fahrenheit. In some embodiments the thermal assembly 120 may maintain the temperature of the digestion chamber 112a, b to between 95 degrees Fahrenheit and 100 degrees Fahrenheit. In still other embodiments, the thermal assembly 120 may maintain the temperature within the digestion chambers 112a, b to a target temperature substantially corresponding to the natural body temperature of the stomach of the species that the simulator 100 is attempting to replicate (e.g., 98.6 degrees Fahrenheit for a human).

In some embodiments, the thermal assembly 120 may be incorporated into the agitation assembly 116 such that the thermal assembly 120 conveys heat to the sacs 108a, b via the agitation heads 152a, b. In some embodiments, the thermal assembly 120 may physically warm the agitation

heads 152a, b (e.g., specifically the protrusions 160a, b) so that heat is conveyed to the sacs 108a, b through contact between the heads 152a, b and the sacs 108a, b. In other embodiments, the thermal assembly 120 may pump warm air through the agitation heads 152a, b so that it is impinged upon the sacs 108a, b. In such embodiments, the agitation heads 152a, b may include one or more nozzles 122 incorporated therein to allow the hot air to be passed therethrough and directed toward the sacs 108a, b (see FIG. 6). In still other embodiments, all or some of the nozzles may be incorporated into the base 170 of the agitation assembly 116. In still other embodiments, the thermal assembly 120 may be an independent structure from the agitation assembly 116, including its own nozzles to direct hot air at the sacs 108a, b. In still other embodiments, the thermal assembly 120 may include a heating coil positioned within the internal volume 124 to warm the entire volume and the sacs 108a, b contained therein.

To operate the simulator 100, the first fluid 114a may be inserted into the first sac 108a (e.g., into the first digestion chamber 112a) and the second fluid 114b may be inserted into the second sac 108b (e.g., into the second digestion chamber 112b). In some embodiments, the first and second fluids 114a, b have a pH between 1.3 and 3.5. In other embodiments, the first and second fluids 114a, b have a pH between 1.5 and 3.5. In other embodiments, the first and second fluids 114a, b have a pH between 1.3 and 1.8. In still other embodiments, the first and second fluids 114a, b have a pH between 1.5 and 1.8. In still other embodiments, the first and second fluids 114a, 114b have a pH between 1.0 and 2.0. In still other embodiments, the first and second fluids 114a, 114b have a pH between 1.0 and 1.8. In still other embodiments, the first and second fluids 114a, 114b have a pH between 1.0 and 3.5. In still other embodiments, the first and second fluids 114a, 114b have a pH between 1.0 and 3.0. In still other embodiments, the first and second fluids 114a, 114b have a pH between 1.2 and 1.8. In some embodiments, the first and second fluids 114a, b have a pH between 1.3 and 3.0. In other embodiments, the first and second fluids 114a, b have a pH between 1.5 and 3.0. In still other embodiments, the first and second fluids 114a, b may have different pH values. In still other embodiments, the first and second fluids 114a, b may have the same pH values. In still other embodiments, the first and second fluids 114a, b may include hydrochloric acid. In still other embodiments, the first and second fluids 114a, b may have a pH that generally corresponds with the stomach fluids present in the stomach of the species the simulator is attempting to simulate.

With the first and second fluids 114a, b installed, any supplemental substances SS (e.g., foodstuffs, medicines, supplements, liquids, solids, and the like) may be inserted into the digestion chambers 112a, b of both sacs 108a, b and both chambers 112a, b sealed.

With each sac 108a, b prepped, the sacs 108a, b can then be inserted into the liner 110. To do so, the sacs 108a, b are inserted into the internal volume 142 of the liner 110 via the corresponding windows 158 (see FIG. 1). The combined sacs 108a, b and liner 110 are then placed into the volume 124 of the frame 104 via the open end 136 and set atop the agitation assembly 116. When doing so, the first sac 108a generally rests atop the first agitation head 152a (e.g., in engagement with the first head’s 152a protrusion 160a, b) and the second sac 108b generally rests atop the second agitation head 152b (e.g., in engagement with the second head’s 152b protrusions 160a, b; see FIG. 1). As shown in FIG. 1, the final positioning also results in the body 148 of the liner 110 being positioned between both sacs 108a, b and their corresponding agitation heads 152a, b.

With the sacs 108a, b installed in the frame 104, the simulator 100 may then be activated, whereby both agitation heads 152a, b begin rotating about their corresponding axes of rotation 174a, b. By doing so, both agitation heads 152a, b deform the bodies 140a, b of their respective sacs 108a, b causing the contents inside (e.g., the first fluid 114a and supplemental contents SS in the first sac 108a and the second fluid 114b and supplemental contents SS in the second sac 108b) to begin to agitate. At the same time, the thermal assembly 120 begins applying heat to both sacs 108a, b causing the internal temperatures to rise toward a pre-set temperature. During operation, each agitation head 152a, b may rotate in a direction and speed that is selected to generally reproduce the digestive conditions within the gastrointestinal element being simulated. In still other embodiments, the two agitation heads 152a, b may rotate at different directions and speeds. In still other embodiments, a movement program may be prepared whereby the speed and direction may be altered over the course of the simulation itself.

The agitation and heat processes continue for a pre-determined period of time, at which the user is able to visually watch the breakdown of the supplemental substances SS via the windows 158 and transparent aspects of the bodies 140a, b of the sacs.

After the simulation is complete, the simulator 100 may be disassembled and the contents of the two sacs 108a, b discharged via the corresponding access ports 144.

1. A gastrointestinal tract simulator for simulating the breakdown of a first substance, the gastrointestinal tract simulator comprising:
a sac having a deformable body and at least partially defining a first chamber therein, wherein the first chamber is configured to receive the first substance therein;
a first fluid contained within the first chamber;
an agitation assembly engaging the sac, wherein the agitation assembly is configured to deform the body of the sac.

2. The gastrointestinal tract simulator of claim 1, wherein the body is impermeable to the first liquid.

3. The gastrointestinal tract simulator of claim 1, wherein the body at least partially forms a first layer, the gastrointestinal tract simulator further comprising a second layer at least partially encompassing the first layer.

4. The gastrointestinal tract simulator of claim 3, wherein the second layer is formed from a different material than the first layer.

5. The gastrointestinal tract simulator of claim 4, wherein the first layer is formed from a plastic material and the second layer is formed from a fabric.

6. The gastrointestinal tract simulator of claim 1, further comprising a rigid frame defining a first interior volume therein, and wherein the sac is at least partially positioned within the first interior volume.

7. The gastrointestinal tract simulator of claim 1, wherein the first fluid includes hydrochloric acid.

8. The gastrointestinal tract simulator of claim 1, wherein the first fluid has a pH between 1.3 and 3.5.

9. The gastrointestinal tract simulator of claim 1, wherein the agitation assembly includes an agitation head rotatable about a first axis, and wherein rotation of the agitation head about the first axis causes the body of the sac to deform.

10. The gastrointestinal tract simulator of claim 9, wherein the agitation head includes a protrusion extending from the agitation head, wherein the protrusion is spaced a distance from the first axis, and wherein the protrusion is configured to engage the sac.

11. The gastrointestinal tract simulator of claim 10, wherein the protrusion extends from the agitation head in a direction parallel to the first axis.

12. The gastrointestinal tract simulator of claim 9, wherein the agitation head is positioned completely outside the first chamber.

13. The gastrointestinal tract simulator of claim 1, further comprising a heater assembly, and wherein the heater assembly is configured to maintain at least a portion of the agitation head at a pre-determined temperature.

14. The gastrointestinal tract simulator of claim 13, wherein the heater assembly is configured to maintain the first fluid between 90 and 105 degrees Fahrenheit.

15. A gastrointestinal tract simulator for simulating the breakdown of a first substance therein, the gastrointestinal tract simulator comprising:
a sac having a deformable body and at least partially defining a first chamber therein, wherein the first chamber is configured to receive the first substance therein;
a first fluid contained within the first volume;
an agitation assembly configured to agitate the first fluid within the first volume.

16. The gastrointestinal tract simulator of claim 15, further comprising a heater assembly configured to maintain the first fluid at a predetermined temperature.

17. A method of simulating the breakdown of a first substance within a gastrointestinal tract, the method comprising:
providing a sac with a deformable body, where the sac defines a first chamber therein;
at least partially filling the first chamber with a first fluid;
placing the first substance within the first chamber;
agitating the first fluid within the first chamber; and
warming the first fluid to a temperature between 90 and 105 degrees.

18. The method of claim 17, wherein placing the first substance within the first chamber includes placing a foodstuff within the first chamber.

19. The method of claim 17, wherein agitating the first fluid within the first chamber includes deforming the body of the sac.

20. The method of claim 17, wherein filling the first chamber with a first fluid includes filling the first chamber with a first fluid having a pH between 1.3 to 3.5.
